(19) United States
(12) Patent Application Publication
(10) Pub. No.: US 2012/0202421 A1
(43) Pub. Date: Aug. 9, 2012

(54) MOBILE WIRELESS COMMUNICATIONS DEVICE TO DETECT MOVEMENT OF AN ADJACENT NON-RADIATING OBJECT AND ASSOCIATED METHODS

(75) Inventors: Vahid MOOSAVI, Kitchener (CA); Scott Douglas Rose, Waterloo (CA)

(73) Assignee: Research In Motion Limited, Waterloo (CA)

(21) Appl. No.: 13/021,052

(22) Filed: Feb. 4, 2011

(51) Int. Cl. H04B 5/02

(52) U.S. Cl. 455/41.1

(57) ABSTRACT

A mobile wireless communications device includes a wireless transceiver, a Near Field Communications (NFC) device, and a processor. The processor is configured to cooperate with the wireless transceiver for wireless communications. The processor is also configured to detect movement of a non-radiating object adjacent the NFC device, and perform at least one function based upon the detected movement.

### TECHNICAL FIELD

The present disclosure relates to the field of mobile wireless communications devices, and, more particularly, to mobile wireless communications devices including Near Field Communications (NFC) circuits.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices also allow users to send and receive electronic mail (e-mail) messages wirelessly and access the Internet via a cellular network and/or a wireless local area network (WLAN), for example. In addition, these devices may allow users to send Short Messaging Service (SMS) messages, Personal Identification Number (PIN) messages, and instant messages.

Given the amount of information now stored on a mobile device itself and the pervasive use of e-mail and PDA features, some users may desire quick access to their upcoming appointments, most recently received e-mails, etc. Therefore, some mobile devices may display a home screen providing a variety of data, such as the date and time, together with the most recently received e-mails or SMS messages and upcoming appointments. Consequently, such a home screen provides a variety of information in one location, readable with a quick glance.

Since the reduction of power consumption is a common concern with a mobile device, some mobile devices may dim (or even shut off) their display when not in use. This deprives a user the ability to quickly glance at the home screen, or any other open screen, without reactivating the display. Since reactivating the display to merely view the home screen may be burdensome, new methods of reactivating a display, or performing a device function, are desirable.

### BRIEF DESCRIPTION OF THE DRAWINGS

FIG. 1 is a schematic block diagram of a mobile wireless communications device in accordance with the present disclosure.

FIG. 2 is a schematic block diagram of another embodiment of a mobile wireless communications device in accordance with the present disclosure.

FIG. 3 is a schematic block diagram of a further embodiment of a mobile wireless communications device in accordance with the present disclosure.

FIG. 4 is a flowchart of a method of operating a mobile wireless communications device in accordance with the present disclosure.

FIG. 5 is a high-level block diagram showing example additional components that can be used in the wireless communications device shown in FIG. 1.

### DETAILED DESCRIPTION

The present description is made with reference to the accompanying drawings, in which various embodiments are shown. However, many different embodiments may be used, and thus the claims should not be construed as limited to the embodiments set forth herein. Rather, these embodiments are provided so that this disclosure will be thorough and complete. Like numbers refer to like elements throughout, and prime notation is used to indicate similar elements in alternative embodiments.

Generally speaking, a mobile wireless communications device may include a wireless transceiver, a Near Field Communications (NFC) device, and a processor coupled with the wireless transceiver and the NFC device. The processor may be configured to cooperate with the wireless transceiver for wireless communications, and detect movement of a non-radiating object adjacent the NFC device. The processor may also be configured to perform at least one function based upon detection of movement.

The mobile wireless communications device may have an accelerometer coupled with the processor. The processor may be configured to perform the at least one function further based upon data from the accelerometer. Additionally or alternatively, the detection of movement may be based upon the accelerometer.

In some applications, the processor may be switchable between a first mode and a second mode, and the at least one function may comprise switching between the first mode and the second mode. The first mode may comprise a low power mode, and the second mode may comprise an active mode.

A display may be coupled with the processor. In addition, the at least one function may comprise activation of the display. The processor may be configured to detect movement based upon an impedance change in the NFC device. The wireless transceiver may comprise a cellular transceiver.

A method aspect is directed to a method of operating a mobile wireless communications device comprising a processor cooperating with a wireless transceiver for wireless communications. The method may include detecting movement of a non-radiating object adjacent a NFC device, using the processor. The method may also include performing at least one function based upon the detected movement, using the processor.

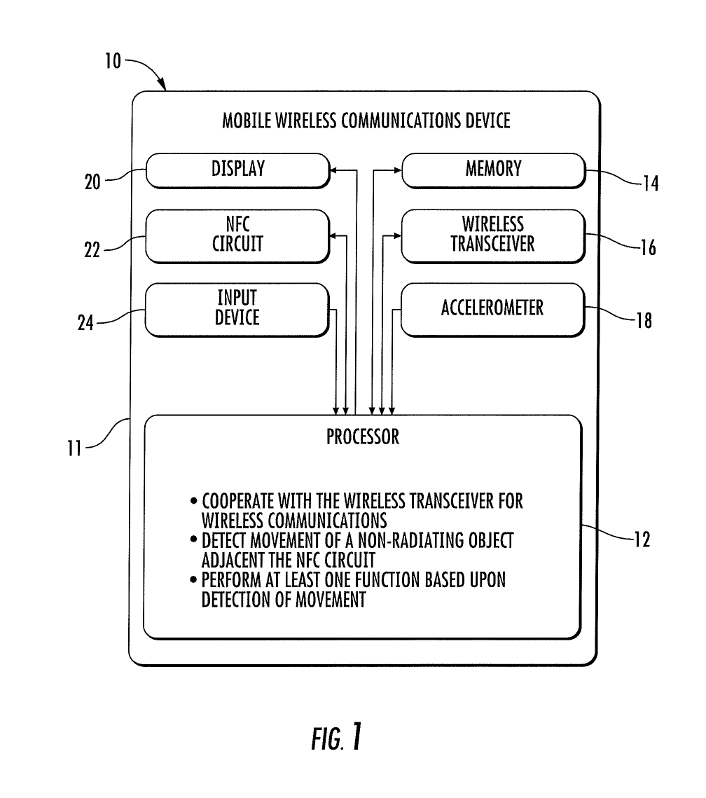

With reference initially to FIG. 1, a mobile wireless communications device 10 in accordance with the present disclosure is now described. Example mobile wireless communications devices 10 may include portable or personal media players (e.g., music or MP3 players, video players, etc.), remote controls (e.g., television or stereo remotes, etc.), portable gaming devices, portable or mobile telephones, smartphones, tablet computers, etc. The mobile wireless communications device 10 includes a portable housing 11 carrying a processor 12 that is, in turn, coupled to a memory 14, a wireless transceiver 16, an accelerometer 18, a display 20, a Near Field Communications (NFC) circuit 22, and an input device 24. The memory 14 may include both volatile portions, such as Random Access Memory (RAM), and non-voltile portions, such as Flash RAM, in some applications. The display 20 may comprise an Organic Light Emitting Diode (OLED) display, or may comprise a Liquid Crystal Display (LCD) or other suitable display. The input device 24 may comprise a keyboard, touch sensitive pad, trackball, or thumbwheel, for example. In addition, the input device 24 may include any number of separate components, such as a keyboard and a touch sensitive pad. Further, it should be appreciated that the display 20 may comprise a touch sensitive display and may therefore act as at least a portion of the input device 24. The wireless transceiver 16 may include a cellular transceiver or a WLAN transceiver, for example, and the processor 12 cooperates with the wireless transceiver for wireless communications.

In some applications, the processor 12 is switchable from a first mode of operation to a second mode of operation. For example, the processor 12 may be switchable from a low power mode to an active mode. By low power mode, it is meant that the processor is operating in a state that conserves power, for example by running at a lower frequency than optimal for performance. Such a low power mode is useful for conserving power, especially when the mobile wireless communications device 10 is not in active use. As such, the processor 12 may be configured to switch itself from the active mode to the lower power mode after a given period of time during which it has not been in use.

The processor 12 may display a home screen on the display 20. This home screen may be a default screen, and may include a variety of data such as the date and time, a number of recent e-mail or SMS messages, and a number of missed calls. The home screen may even include portions of recently received e-mail and SMS messages, and weather forecasts, for example. Indeed, this home screen may be configurable to display a variety of information about, and accessible by, the mobile wireless communications device 10.

By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

In the mobile wireless communications device 10 of the present disclosure, however, the NFC circuit 22 is also used for additional functions unrelated to data communications with another device. For example, the processor 12 detects movement of a non-radiating object adjacent the NFC circuit 22, and performs at least one function based upon the detected movement. By a non-radiating body, it is meant that the body does not radiate electromagnetic waves in a frequency typically used for wireless communications. For example, a human body (or portion thereof, such as a hand), does not radiate such electromagnetic waves typically used for wireless communications (i.e. used for cellular communications, Bluetooth™ communications, or NFC communications). Moreover, it should be understood that such a non-radiating body also does not radiate electromagnetic waves, or an electromagnetic field, of a type that would be detected by a typical Hall-effect or magnetic field sensor.

This advantageously allows the processor 12 to detect, via the NFC circuit 22, a portion of a human body moving adjacent the NFC circuit 22, and to then, in response, perform at least one function. The at least one function may include switching the processor 12 between the first and second modes, activating the display 20, activating a backlight of the display or the keyboard 24, etc. The at least one function may include other functions, such as changing the active ringer of the mobile wireless communications device 10 (for example, from a vibrate mode to an audible ringer mode). In this disclosure, performing the at least one function may be referred to as “awakening” the mobile wireless communications device 10.

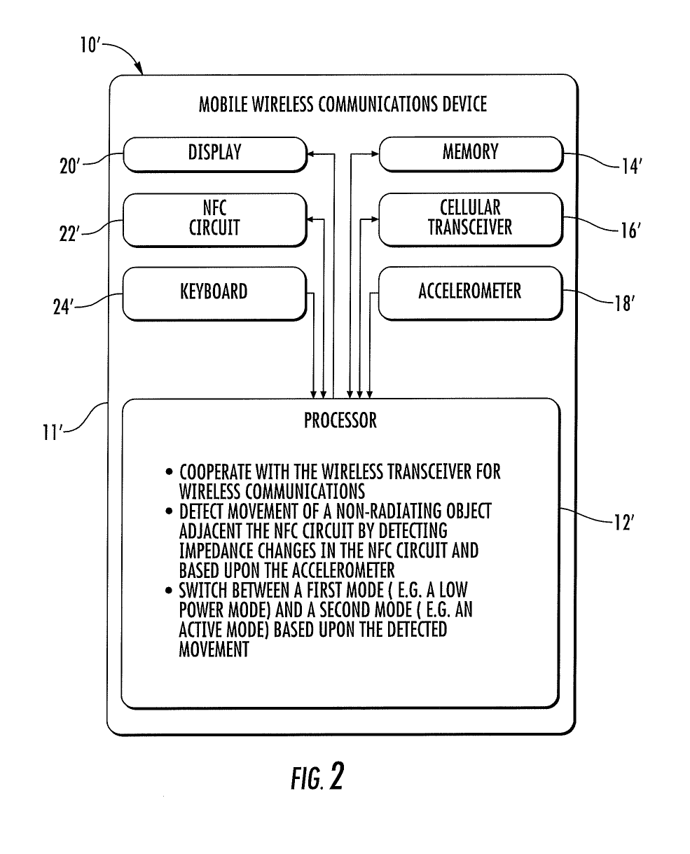

With additional reference to FIG. 2, it shall be understood that the processor 12, in some applications, detects movement of the non-radiating object adjacent the NFC circuit 22 by detecting impedance changes in the NFC circuit, and based upon the accelerometer 18. By detecting movement of the non-radiating object adjacent the NFC circuit 22′ based upon the accelerometer 18′, it is meant that the processor 12′ either begins the process of detecting movement of a non-radiating object, or does not, based upon the accelerometer 18′. For example, if the processor 12′ determines that the mobile wireless communications device 10′ is at rest, via the accelerometer 18′, it may then begin the process of detecting movement of a non-radiating object adjacent the NFC circuit 22′. Likewise, if the processor determines that the mobile wireless communications device 10′ is not at rest, it may not begin the processor detecting movement of a non-radiating object until such time as the mobile wireless communications device is at rest.

After a successful detection, the processor 12′ then switches itself between a low power mode and an active mode based upon detected movement, for example from the lower power mode to the active mode. This functionality advantageously allows the processor 12′ to be switched between the lower power mode and the active mode without physical contact being made with the mobile wireless communications device 10′.

As stated earlier, the movement of the non-radiating object adjacent the NFC circuit 22′ is detected based upon impedance changes in the NFC circuit 22′. By this, it is meant that the NFC circuit 22′ emits a series of radio-frequency pulses, and the processor 12′ monitors the impedance of the load being driven by the NFC circuit 22′, which typically comprises a NFC antenna. The presence of a non-radiating body near the NFC antenna alters the impedance of the antenna, and thus the impedance seen by the portion of the NFC circuit 22′ driving the antenna. This impedance change results from a typical person being made of, for example, 60% water. The processor 12′ detects this impedance change and interprets it as indicating movement of a non-radiating object adjacent the NFC circuit 22′. Elements not specifically discussed are similar to those in the mobile wireless communications device 10 as discussed above and shown in FIG. 1, and require no further discussion herein.

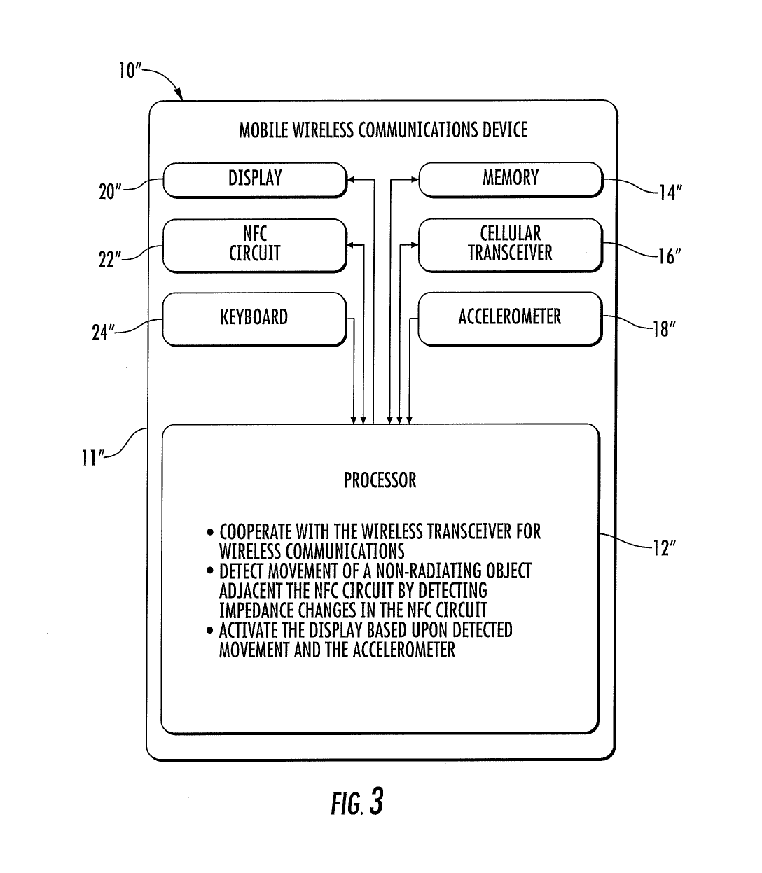

In an alternative embodiment shown in FIG. 3, the processor 12″ detects movement of the non-radiating object adjacent the NFC circuit 22″ by detecting impedance changes in the NFC circuit. Here, the processor 12″ performs the at least one function (here, activation of the display) based upon detected movement and the accelerometer 18″.

By performing the at least one function based upon the accelerometer 18″, it is meant that the processor 12″ may perform the function or not, even if movement of a non-radiating object adjacent the NFC circuit 22″ has been detected, based upon the accelerometer 18″. For example, if the processor 12″ determines that the mobile wireless communications device 10″ is at rest, via the accelerometer 18″, it may then activate the display 20″ based upon detected movement. Likewise, if the processor 12″ determines that the mobile wireless communications device 10″ is not at rest, via the accelerometer 18″, it may then not activate the display 20″ even if movement is detected. Elements not specifically discussed are similar to those in the mobile wireless communications device 10 as discussed above and shown in FIG. 1, and require no further discussion herein.

It should be understood that the above disclosed embodiments are not limited to the features as disclosed. Indeed, these features may be mixed and matched among the embodiments. For example, the mobile wireless communications device 10′ of FIG. 2 may activate the display 20′ based upon detected movement, in addition to, or instead of, switching between the low power mode and the active mode. Likewise, the mobile wireless communications device 10′ may switch the processor 12′ between the low power mode and the active mode also based upon the accelerometer 18′. Similarly, the mobile wireless communications device 10″ of FIG. 3 may switch the processor 12″ between the low power mode and the active mode based upon detected movement, in addition to activating the display 20″ based upon detected movement and the accelerometer.

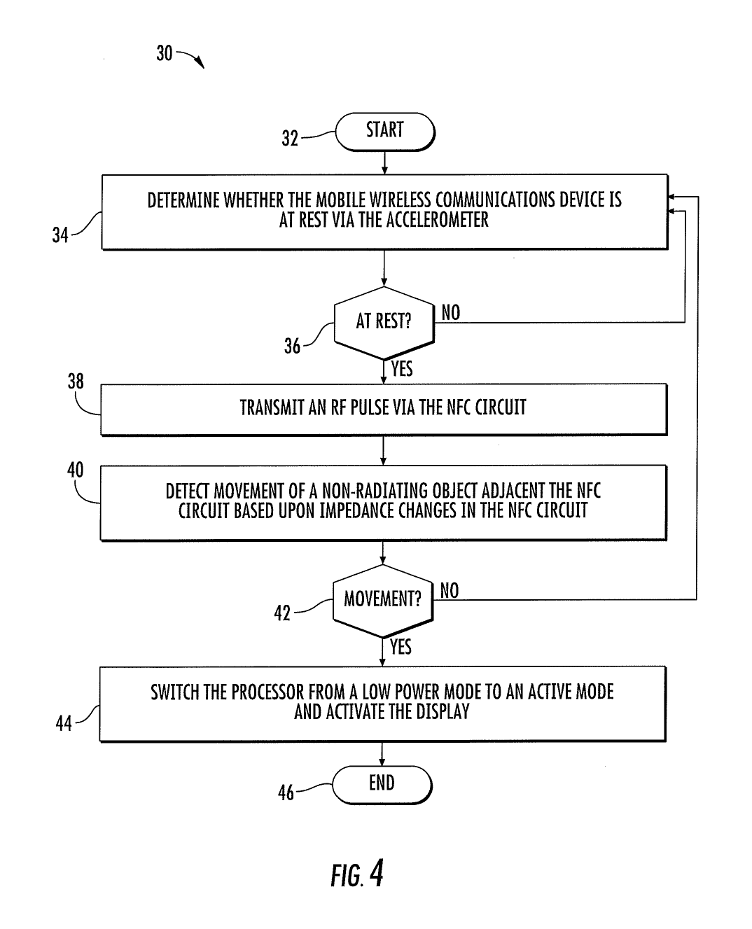

A typical operation of the mobile wireless communications device 10 of FIG. 1 is now described with reference to the flowchart 30 of FIG. 4. Here, after the start (Block 32), the processor 12 determines whether the mobile wireless communications device 10 is at rest, via the accelerometer 18″ (Block 34). If the mobile wireless communications device 10 is not at rest (Block 36), the processor 12 continues to monitor the accelerometer 18 until such time as it determines that the mobile wireless communications device 10 is indeed at rest.

If the mobile wireless communications device 10 is at rest (Block 36), the processor 12 transmits an RF pulse via the NFC circuit 22 (Block 38). The processor 12 then detects movement of a non-radiating object adjacent the NFC circuit 22 based upon impedance changes in the NFC circuit 22 caused by the presence of an adjacent non-radiating object (Block 40). If movement is not detected (Block 42), the processor 12 then goes back to determining whether the mobile wireless communications device 10 is at rest via the accelerometer 18 (Block 34).

If movement is detected (Block 42), the processor 12 switches itself from a lower power mode to an active mode and activates the display (Block 44). Block 46 indicates the end of the sample operation of the mobile wireless communications device 10.

This operation allows the mobile wireless communications device 10 to be awakened (i.e. the display is activated and the processor is switched to the active mode) without being physically touched. This may be particularly convenient when the mobile wireless communications device 10 is at rest on a surface, such as a desk, and it is desired to see the home screen thereof. Rather than using physical contact to pick up the mobile wireless communications device 10 and to activate the input device 24, a simple wave of the hand may awaken the mobile wireless communications device and allow quick and easy viewing of the home screen.

It should be understood that the processor 12 may be configured place the mobile wireless communications device 10 in a “locked” mode, for example based upon the input device 24 or upon passage of a period of time. To exit this “locked” mode, and enable regular operation of the mobile wireless communications device 10, an authentication may be performed. The authentication may be the entry of a password via the input device 10, or the entry of a given sequence of keys via the input device 10, for example. When awakened from the “locked” mode by a wave of the hand, the display of the mobile wireless communications device 10 may be activated, but input of the authentication will have to be performed before the mobile wireless communications device is returned to a normal mode of operation, in some applications.

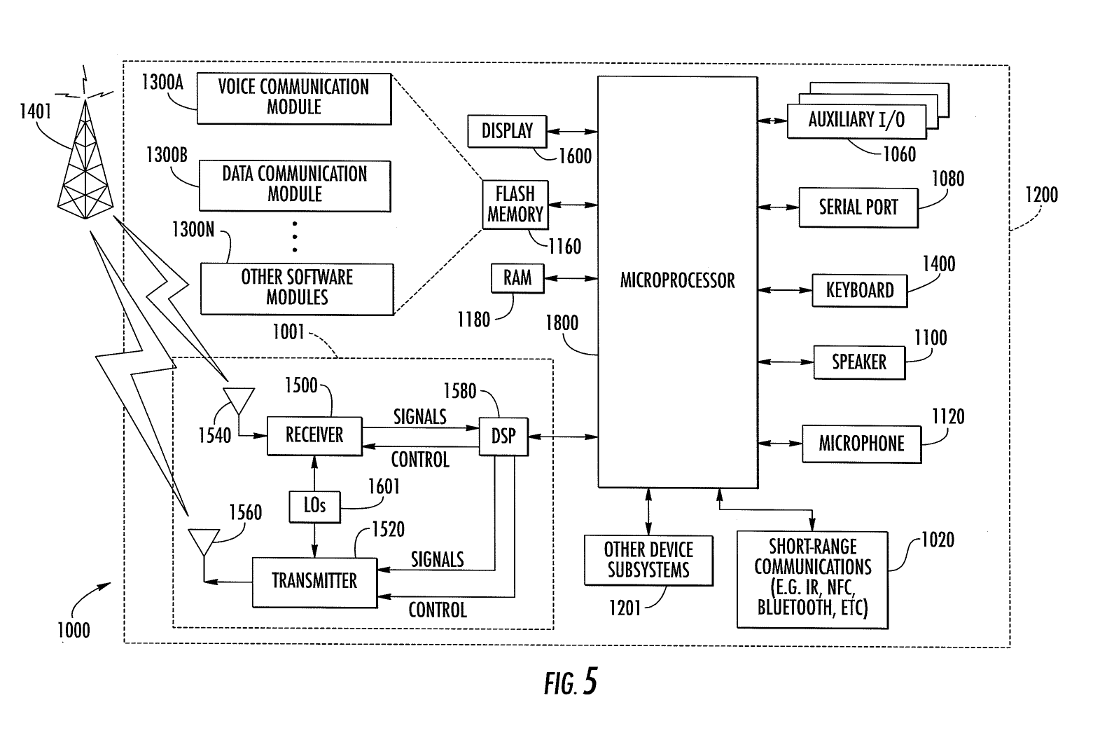

Example components of a mobile wireless communications device 1000 that may be used in accordance with the above-described embodiments are further described below with reference to FIG. 5. The device 1000 illustratively includes a housing 1200, a keyboard or keypad 1400 and an output device 1600. The output device shown is a display 1600, which may comprise a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 5. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) sensor for communicating with a NFC device or NFC tag via NFC communications.

Many modifications and other embodiments of the disclosure will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed is:

1. A mobile wireless communications device comprising:
a wireless transceiver;
a Near Field Communications (NFC) device;
a processor coupled with the wireless transceiver and the NFC device, the processor being configured to
cooperate with said wireless transceiver for wireless communications,
detect movement of a non-radiating object adjacent said NFC device, and
perform at least one function based upon detection of movement.

2. The mobile wireless communications device of claim 1, further comprising an accelerometer coupled with the processor; and wherein said processor is configured to perform the at least one function further based upon data from said accelerometer.

3. The mobile wireless communications device of claim 1, further comprising an accelerometer coupled with the processor; and wherein the detection of movement is based upon said accelerometer.

4. The mobile wireless communications device of claim 1, wherein said processor is switchable between a first mode and a second mode; and wherein the at least one function comprises switching between the first mode and the second mode.

5. The mobile wireless communications device of claim 4, wherein the first mode comprises a low power mode; and wherein the second mode comprises an active mode.

6. The mobile wireless communications device of claim 1, further comprising a display coupled with said processor; and wherein the at least one function comprises activation of said display.

7. The mobile wireless communications device of claim 1, wherein said processor is configured to detect movement based upon an impedance change in said NFC device.

8. The mobile wireless communications device of claim 1, wherein said wireless transceiver comprises a cellular transceiver.

9. A mobile wireless communications device comprising:
an accelerometer;
a wireless transceiver;
a Near Field Communications (NFC) device;
a processor coupled with said accelerometer and said NFC device, the processor being configured to
cooperate with said wireless transceiver for wireless communications,
detect movement of a non-radiating object adjacent said NFC device based upon impedance changes in said NFC device and based upon said accelerometer, and
perform at least one function based upon detection of movement.

10. The mobile wireless communications device of claim 9, wherein said processor is switchable between low power and active modes; and wherein the at least one device function comprises switching between the low power and active modes.

11. The mobile wireless communications device of claim 9, further comprising a display coupled with said processor; and wherein the at least one function comprises activation of said display.

12. A mobile wireless communications device comprising:
an accelerometer;
a wireless transceiver;
a Near Field Communications (NFC) device;
a processor coupled with the accelerometer, the wireless transceiver and the NFC device, the processor being configured to
cooperate with said wireless transceiver for wireless communications,
detect movement of a non-radiating object adjacent said NFC device based upon impedance changes in said NFC device, and
perform at least one function based upon detection of movement and based upon said accelerometer.

13. The mobile wireless communications device of claim 12, wherein said processor is switchable between low power and active modes; and wherein the at least one device function comprises switching between the low power and active modes.

14. The mobile wireless communications device of claim 12, further comprising a display coupled with said processor; and wherein the at least one device function comprises activation of said display.

15. A method of operating a mobile wireless communications device comprising a processor cooperating with a wireless transceiver for wireless communications, the method comprising:
detecting movement of a non-radiating object adjacent a NFC device, using the processor; and
performing at least one function based upon the detected movement, using the processor.

16. The method of claim 15, wherein the at least one function is further performed based upon data from an accelerometer.

17. The method of claim 15, wherein movement is further detected based upon data from an accelerometer.

18. The method of claim 15, wherein the at least one function comprises switching between the processor between a first mode and a second mode.

19. The method of claim 15, wherein the at least one device function comprises activation of a display.

20. The method of claim 15, wherein movement is detected based upon an impedance change in the NFC circuit.
